(19) United States
(12) Patent Application Publication
(10) Pub. No.: US 2009/0009690 A1
(43) Pub. Date: Jan. 8, 2009

(54) LIGHT EMISSION DEVICE AND DISPLAY DEVICE USING THE LIGHT EMISSION DEVICE AS LIGHT SOURCE

(75) Inventors: Yoon-Jin Kim, Gyeonggi-do (KR); Jae-Myung Kim, Gyeonggi-do (KR); Kyu-Nam Joo, Yongin-si (KR); Hyun-Ki Park, Yongin-si (KR); Young-Suk Cho, Yongin-si (KR); Hee-Sung Moon, Yongin-si (KR); So-Ra Lee, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd, Suwon-si (KR)

(21) Appl. No.: 12/057,268

(22) Filed: Mar. 27, 2008

(30) Foreign Application Priority Data
Jul. 3, 2007 (KR) 10-2007-0066582

(51) Int. Cl. G02F 1/13357; H01J 1/88

(52) U.S. Cl. 349/69; 313/244

(57) ABSTRACT

A light emission device for improving high voltage stability and a display device using the same as a light source includes first and second substrates facing each other, an electron emission unit located on one side of the first substrate and including a plurality of electron emission elements, and a light emission unit located on one side of the second substrate and emitting a visible light. Each of the electron emission elements includes first electrodes spaced apart from each other by a predetermined interval along a first direction of the first substrate, second electrodes arranged between the first electrodes along the first direction, and first electron emission regions electrically connected to the first electrodes and formed at a predetermined height lower than that of the first electrodes.

### CROSS-REFERENCE TO RELATED APPLICATION

This application claims priority to and the benefit of Korean Patent Application No. 10-2007-0066582, filed in the Korean Intellectual Property Office on Jul. 3, 2007, the entire contents of which is incorporated herein by reference.

### BACKGROUND

1. Technical Field

The present disclosure relates to a light emission device, more particularly, to a light emission device with an improved structure of an electron emission unit and a display device using the light emission unit as its light source.

2. Description of the Related Art

There are many different types of light emission devices that radiate visible light. One type of light emission device includes a structure in which a phosphor layer and an anode electrode are disposed on a front substrate, and electron emission regions and driving electrodes are disposed on a rear substrate. The front and rear substrates are sealed to each other at their peripheries using a sealing member, and the inner space between the front and rear substrates is evacuated to form a vacuum vessel.

The driving electrodes include cathode electrodes and gate electrodes spaced apart from each other in parallel manner, and the electron emission regions are disposed on a side surface of the cathode electrodes facing the gate electrodes. The driving electrodes and the electron emission regions form an electron emission unit.

The light emission device is driven by supplying a predetermined driving voltage to the cathode and gate electrodes and supplying several thousand Volts of positive DC voltage (anode voltage) to the anode electrode. Then, an electric field is formed around electron emission regions due to the voltage difference between the cathode and gate electrodes, and electrons are emitted therefrom. The emitted electrons collide with a corresponding phosphor layer by the anode voltage, thereby emitting light.

In the light emission device described above, the luminance thereof is improved by increasing an anode voltage because the luminance of a light emission surface is proportional to the anode voltage. However, since the electron emission regions are directly influenced by an anode electric field in the light emission device, the anode electric field around the electron emission regions is strengthened as the anode voltage increases, and diode emission may occur, in which the anode electric field unintentionally emits electrons.

In the light emission device, the probability of inducing arc discharge in a vacuum vessel increases as an anode voltage increases due to electric charge charged at a surface of internal structure or remaining gas in the vacuum vessel. Since the light emission device has low high-voltage stability and limited increases in the anode voltage, it is difficult to improve the luminance.

Also, although the cathode and gate electrodes are generally formed through a so-called thin film process, such as by sputtering or vacuum deposition, electrodes formed through such thin film processes generally have a relatively high resistances. Therefore, in operation of the light emission device, the luminance uniformity of the light emission device may be deteriorated due to voltage drop generated at the driving electrodes.

### SUMMARY OF THE INVENTION

Exemplary embodiments provide a light emission device having advantages of suppressing arc discharge by increasing high voltage stability and of improving the luminance of a light emission surface by increasing an anode voltage and a display device using the light emission device as its light source.

An exemplary embodiment provides a light emission device including first and second substrates facing each other with a predetermined distance therebetween, an electron emission unit located on one side of the first substrate and including a plurality of electron emission elements, and a light emission unit located on one side of the second substrate and emitting a visible light. Each of the electron emission elements includes first electrodes spaced apart from each other by a predetermined interval along a first direction of the first substrate, second electrodes arranged between the first electrodes along the first direction, and first electron emission regions electrically connected to the first electrodes and formed at a predetermined height lower than that of the first electrodes.

A height difference between the first electrodes and the first electron emission regions may be about 1 to 10 μm, and the first electrodes and the second electrodes may be disposed at about 30 to 200 μm of interval.

The electron emission elements may further include second electron emission regions that are electrically connected to the second electrodes and formed at a predetermined height lower than that of the second electrodes. A height difference between the second electrodes and the second electron emission regions may be about 1 to 10 μm. The first electron emission regions and the second electron emission regions may be disposed at about 3 to 20 μm of interval.

The first electrodes and the second electrodes may receive a scan driving voltage and a data driving voltage at a first period, respectively, and may receive a data driving voltage and a scan driving voltage at second period, respectively. The first electron emission regions and the second electron emission regions may include carbide-derived carbon.

Another exemplary embodiment provides a display device including a display panel displaying an image, and a light emission device for providing a light to the display panel. The light emission device includes first and second substrates facing each other with a predetermined distance therebetween, an electron emission unit located on one side of the first substrate and including a plurality of electron emission elements, and a light emission unit located on one side of the second substrate and emitting a visible light. Each of the electron emission elements includes first electrodes spaced apart from each other by a predetermined interval along a first direction of the first substrate, second electrodes arranged between the first electrodes along the first direction, and first electron emission regions electrically connected to the first electrodes and formed at a predetermined height lower than that of the first electrodes.

The display panel may form first pixels, the light emission device may form second pixels less than the first pixels, and each of the second pixels may independently emit light corresponding gray level of the first pixels. Each of the second pixels may include one of the electron emission elements, and the display panel may be a liquid crystal display panel.

Some embodiment provide a light emission device comprising: first and second substrates facing each other with a predetermined distance therebetween; an electron emission unit disposed on a first side of the first substrate, comprising a plurality of electron emission elements; and a light emission unit disposed on a first side of the second substrate, configured for emitting visible light, wherein each electron emission element comprises first electrodes spaced apart from each other by a predetermined interval along a first direction of the first substrate; second electrodes arranged between the first electrodes along the first direction; and first electron emission regions electrically coupled to the first electrodes with a predetermined height lower than a height of the first electrodes.

In some embodiments, a height difference between the first electrodes and the first electron emission regions is from about 1 μm to about 10 μm. In some embodiments, a spacing between the first electrodes and the second electrodes is from about 30 μm to about 200 μm.

In some embodiments, the electron emission element comprises second electron emission regions electrically coupled to the second electrodes with a predetermined height that is lower than a height of the second electrodes.

In some embodiments, a height difference between the second electrodes and the second electron emission regions is from about 1 μm to about 10 μm. In some embodiments, a spacing between the first electron emission regions and the second electron emission regions is from about 3 μm to about 20 μm.

In some embodiments, the first electrodes and the second electrodes are configured to receive a scan driving voltage and a data driving voltage during a first time period, and to receive a data driving voltage and a scan driving voltage during a second time period.

In some embodiments, the first electron emission regions and the second electron emission regions comprises carbide-derived carbon.

In some embodiments, the electron emission element includes a first connection electrode disposed at first ends of the first electrodes and forming a first electrode set together with the first electrodes, and a second connection electrode disposed at first ends of the second electrodes and forming a second electrode set together with the second electrodes.

In some embodiments, the electron emission unit includes first wires coupled to the first connection electrodes of the electron emission elements arranged along a first direction of the first substrate and second wires connected to the second connection electrodes of the electron emission elements arranged along a second direction crossing the first direction.

Some embodiments provide a display device comprising: a display panel configured for displaying an image; and a light emission device configured for providing a light to the display panel, wherein the light emission device comprises a first substrate and a second substrate facing each other with a predetermined distance therebetween; an electron emission unit disposed on a first side of the first substrate, comprising a plurality of electron emission elements; and a light emission unit disposed on a first side of the second substrate and configured for emitting a visible light, wherein each of the electron emission elements comprises first electrodes spaced apart from each other by a predetermined interval along a first direction of the first substrate; second electrodes arranged between the first electrodes along the first direction; and first electron emission regions electrically coupled to the first electrodes, with a predetermined height that is lower than a height of the first electrodes.

In some embodiments, a height difference between the first electrodes and the first electron emission regions is from about 1 μm to about 10 μm. In some embodiments, a spacing between the first electrodes and the second electrodes is from about 30 μm to about 200 μm.

In some embodiments, the electron emission elements include second electron emission regions electrically coupled to the second electrodes, with a predetermined height lower than a height of the second electrodes.

In some embodiments, a height difference between the second electrodes and the second electron emission regions is from about 1 μm to about 10 μm. In some embodiments, a spacing between the first electron emission regions and the second electron emission regions is from about 3 μm to about 20 μm.

In some embodiments, the display panel comprises first pixels, the light emission device comprises second pixels, wherein a number of second pixels is fewer than a number of first pixels, and each of the second pixels is configured for independently emitting light corresponding a gray level of the first pixels.

In some embodiments, each of the second pixels includes an electron emission element.

In some embodiments, the display panel comprises a liquid crystal display panel.

### BRIEF DESCRIPTION OF THE DRAWINGS

FIG. 1 is a partial cross-sectional view of a light emission device according to a first exemplary embodiment.

FIG. 2 is a partial plan view of an electron emission unit shown in FIG. 1.

FIG. 3 is a perspective view of an electron emission element shown in FIG. 2.

FIG. 4 is a cross-sectional view taken along the section line II-II of FIG. 2.

FIG. 5 is a partial cross-sectional view of a light emission device according to a second exemplary embodiment.

FIG. 6 is a partial plan view of an electron emission unit shown in FIG. 5.

FIG. 7 is a perspective view of an electron emission element shown in FIG. 6.

FIG. 8 and FIG. 9 are partial cross-sectional views of a light emission device according to the second exemplary embodiment.

FIG. 10A to FIG. 10D are partial cross-sectional views illustrating a first embodiment of a method of manufacturing an electron emission element in a light emission device according to the second exemplary embodiment.

FIG. 11A to FIG. 11E are partial cross-sectional views illustrating a second embodiment of a method of manufacturing an electron emission element in a light emission device according to the second exemplary embodiment.

FIG. 12 is an exploded perspective view of a display device using the light emission device of one of the first and second exemplary embodiments as its light source.

FIG. 13 is a partial cross-sectional view of a display panel shown in FIG. 12.

### DETAILED DESCRIPTION OF CERTAIN EMBODIMENTS

Certain embodiments will now be described more fully with reference to the accompanying drawings, in which exemplary embodiments are shown, which, however, may be embodied in many different forms and should not be construed as being limited to the embodiments set forth herein. Rather these embodiments are provided so that this disclosure will be thorough and complete, and will fully convey the concept to those skilled in the art.

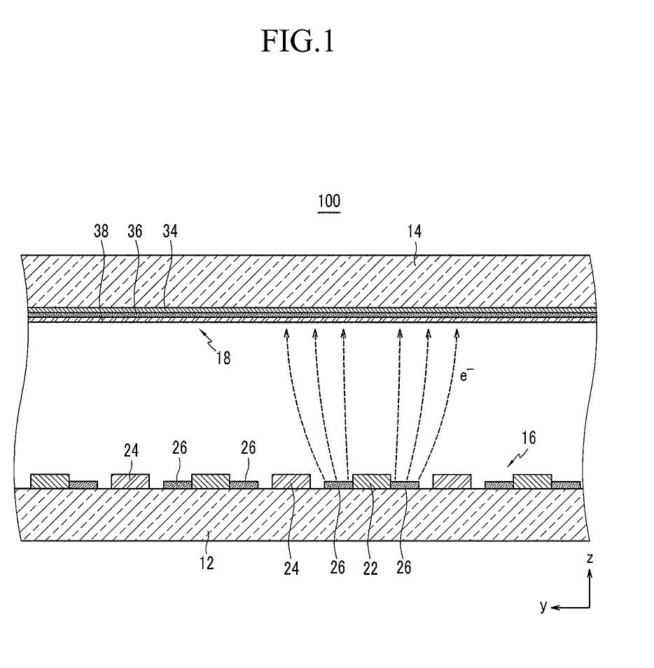

A light emission device according to a first exemplary embodiment of the present invention will be described with reference to FIGS. 1 to 4.

Referring to FIG. 1 to FIG. 3, the light emission device 100 of the present exemplary embodiment includes the first substrate 12 and the second substrate 14, which are arranged opposite to each other in parallel with a predetermined gap therebetween. The first and second substrates 12 and 14 are sealed together along their peripheries with a sealing member (not shown), and the inner space therebetween is evacuated to about 10-6 Torr. Therefore, the first and second substrates 12 and 14, and the sealing member together form a vacuum envelope.

Inside the sealing member, each of the first and second substrates 12 and 14 may be divided into an active area from which visible light is actually emitted and a non-active area surrounding the active area. An electron emission unit 16 is provided on an inner surface of the first substrate 12 at the active area to emit electrons, and a light emission unit 18 is provided on an inner surface of the second substrate 14 at the active area to emit visible light.

The second substrate 14 on which the light emission unit 18 is disposed may be a front substrate of the light emission device 100, and the first substrate 12 on which the electron emission unit 16 is disposed may be a rear substrate of the light emission device 100.

In the present exemplary embodiment, the electron emission unit 16 includes a plurality of electron emission elements 20, in each of which, emission currents, are independently controlled by the following configuration and driving method.

Each of the electron emission elements 20 includes first electrodes 22 spaced apart from each other by a predetermined interval along a first direction of the first substrate 12, e.g., the y-axis direction in the drawings, second electrodes 24 arranged between the first electrodes 22 along the first direction. Electron emission regions 26 are disposed on side surfaces of the first electrodes 22 facing the second electrodes 24, and formed at a lower height than the first electrodes 22. The first and second electrodes 22 and 24 are disposed generally parallel to each other.

The first electrode 22 is a cathode electrode to provide a current to the electron emission regions 26, and the second electrode 24 is a gate electrode to form an electric field around the electron emission regions 26 by a voltage difference from the first electrode 22 to cause the electron emission. The electron emission regions 26 are formed along the length direction of the first electrodes 22 and spaced at a certain distance from the second electrodes 24 so as not to short-circuit with the second electrodes 24.

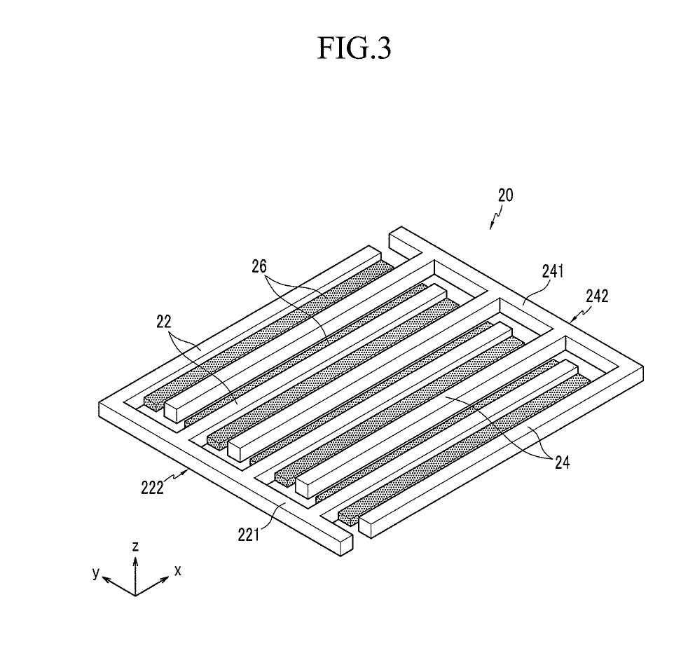

As seen in FIG. 3, a first connection electrode 221 is disposed at an end of each of the first electrodes 22 to form a first electrode set 222 together with the first electrodes 22. A second connection electrode 241 is disposed at an end of each of the second electrodes 24 to form a second electrode set 242 together with the second electrodes 24.

The first and second electrodes 22 and 24 are formed higher than the electron emission regions 26. The first and second electrodes 22 and 24 may be formed through a so-called thick film process such as screen printing or laminating rather than through a thin film process such as sputtering or vacuum depositing.

The electron emission regions 26 may include materials which emit electrons when electric field is applied in a vacuum, such as a carbonaceous material or nanometer-sized material. The electron emission regions 26 may include a material selected from a group consisting of, for example, carbon nanotubes, graphite, graphite nanofibers, diamond, diamond-like carbon, fullerene (C₆₀), silicon nanowires, and combinations thereof.

On the other hand, the electron emission regions 26 may include carbide-derived carbon. The carbide-derived carbon can be manufactured during a process to extract the remaining elements except carbon from a carbide compound by thermal chemical reaction of the carbide compound and a halide-containing gas. The carbide compound may be at least one carbide compound selected from a group consisting of SiC₄, B₄C, TiC, ZrCₓ, Al₄C₃, CaC₂, TiₓTa_{y}C, MoₓW_{y}C, TiNₓC_{y}, and ZrNₓC_{y}. The halide-containing gas may be Cl₂, TiCl₄, or F₂ gas. The electron emission regions 26 including carbide-derived carbon have excellent electron emission uniformity and long life-span.

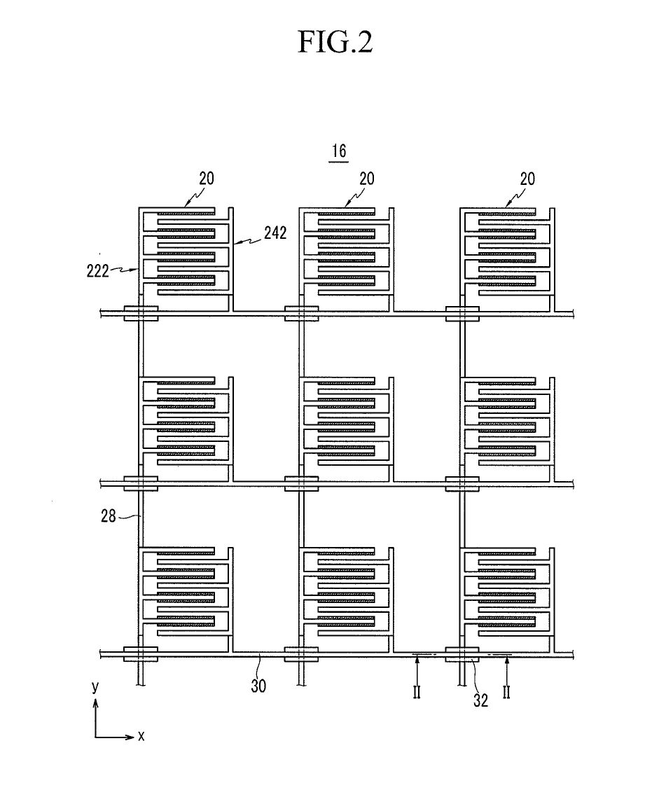

Referring to FIG. 2, the electron emission elements 20 are spaced parallel with each other at a certain distance within the active area of the first substrate 12. First wires 28 and second wires 30 are disposed between the electron emission elements 20 to apply a driving voltage to the first electrodes 22 and the second electrodes 24, respectively.

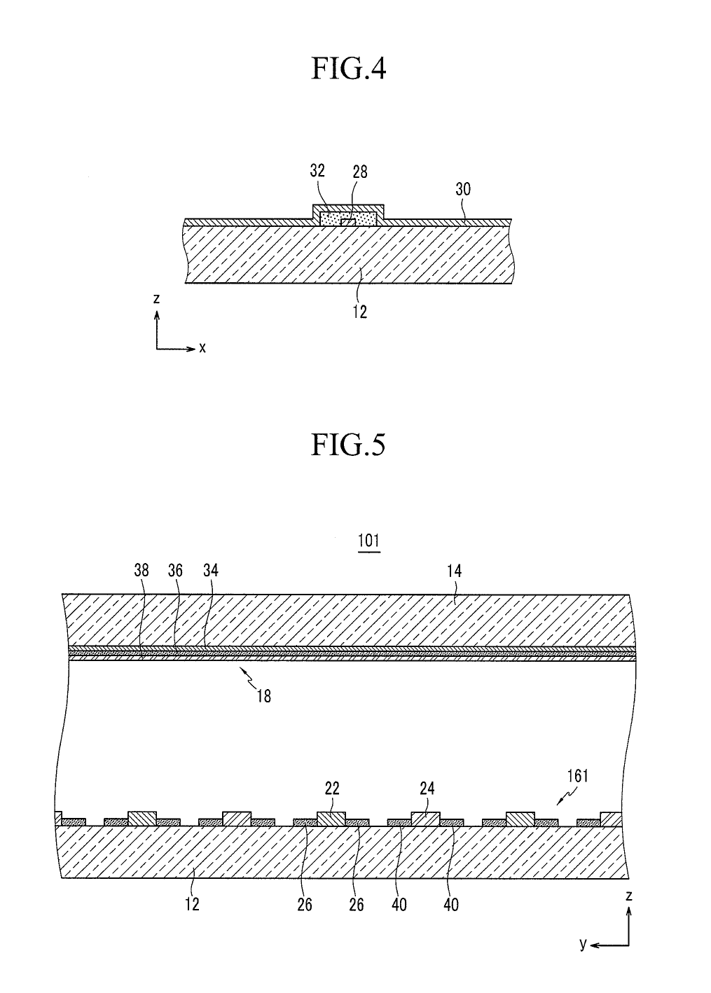

Referring to FIG. 2 and FIG. 4, the first wires 28 are formed along the first direction of the first substrate 12, e.g., the y-axis direction in the drawings, and electrically connected with the first electrode sets 222 of the electron emission elements 20, which are disposed along the same direction. The second wires 30 are formed along a second direction perpendicular to the first direction, e.g., the x-axis direction in the drawings, and electrically connected with the second electrode sets 242 of the electron emission elements 20, which is disposed along the same direction.

In addition, an insulation layer 32 is formed between the first and second wires 28 and 30 at the area where the first and second wires 28 and 30 are crossed each other to prevent the first and second wires 28 and 30 from short-circuiting. The insulation layer 32 is formed wider than the first and second wires 28 and 30.

Referring again to FIG. 1, the light emission unit 18 includes an anode electrode 34, a phosphor layer 36 formed on one side of the anode electrode 34, and a reflective layer 38 covering the phosphor layer 36.

The anode electrode 34 comprises a transparent conductive material, such as ITO (indium tin oxide), so as to transmit visible light emitted from the phosphor layer 36. The phosphor layer 36 may comprise a mixture of red, green, and blue phosphors that emit white light, disposed on the entire active area of the second substrate 14.

The reflective layer 38 may be made of aluminum and formed at a thickness of about several thousands Å, in which fine holes are formed to transmit electron beam. The reflective layer 38 reflects visible light that is emitted toward the first substrate 12 among the visible light emitted from the phosphor layer 36 back to the second substrate 14 so as to improve the luminance of the light emission surface. The aforementioned anode electrode 34 may be omitted, and the reflective layer 38 may function as an anode electrode by receiving an anode voltage.

Disposed between the first and second substrates 12 and 14 at the active area are spacers (not shown) that are able to withstand a compression force applied to the vacuum envelop and to uniformly maintain a gap between the first and second substrates 12 and 14.

In the aforementioned light emission device 100, each electron emission element 20 and the corresponding part of the phosphor layer 36 together comprise one pixel. The light emission device 100 applies a scan driving voltage to one of the first wire 28 and the second wire 30, a data driving voltage to the other of the first wire 28 and the second wire 30, and a positive DC voltage (anode voltage) above about 10 kV to the anode electrode 34.

Then, an electric field is formed around pixels where a voltage difference between the first and second electrodes 22 and 24 is over a threshold value to emit electrons (represented as e⁻ in FIG. 1) therefrom. The emitted electrons collide with the corresponding part of the phosphor layer 36, led by the anode voltage applied to the anode electrode 34 to emit light therefrom. In FIG. 1, for the purpose of convenience, it is illustrated that the electrons are emitted from some of the electron emission regions 26.

In the above light emission device 100, the first and second electrodes 22 and 24 are formed higher than the electron emission regions 26. Therefore, the first electrodes 22 and the second electrodes 24 change the distribution of the electric field around the electron emission regions 26 so as to reduce the effect of the anode electric field on the electron emission regions 26.

Accordingly, even when more than about 10 kV of anode voltage is applied to the anode electrode 34 in order to increase the luminance of the light emission device 100, the first electrodes 22 and the second electrodes 24 deteriorate the anode electric field around the electron emission regions 26, thereby effectively suppressing diode emission by the anode electric field.

As a result, the light emission device 100 according to the present exemplary embodiment can increase the luminance of the light emission surface by raising the anode voltage and accurately control the luminance pixel-by-pixel by suppressing the diode emission. Also, the light emission device 100 can minimize arc occurrence rates by increasing high voltage stability, thereby suppressing inner structure damage caused by arcing.

The first and second electrodes 22 and 24 may be formed with the same thickness and with a height from about 1 μm to about 10 μm higher than the electron emission regions 26. If the height difference between the first electrode 22 and the electron emission region 26 is less than about 1 μm, the shield effect of the anode electric field on the electron emission regions 26 may decrease, and the high voltage stability of the light emission device 100 may be deteriorated. If the height difference between the first electrode 22 and the electron emission region 26 is more than about 10 μm, the emission characteristics of the electron emission regions 26 may be deteriorated, causing the increase of a driving voltage.

If the electron emission regions 26 comprise carbide-derived carbon, and they are formed through screen printing, the electron emission regions 26 may be formed from about 1 μm to about 2 μm thick. If the thickness of the electron emission regions 26 is substantially less than about 1 μm, it may be difficult to make the electron emission regions 26. If the thickness is over about 2 μm, the enhanced electric field effect may be reduced, thereby deteriorating the emission efficiency of the electron emission regions 26. The diameter of the carbide-derived carbon may be about 1 μm.

If the thickness of the electron emission regions 26 is from about 1 μm to about 2 μm, the first and second electrodes 22 and 24 should be formed at from about 3 μm to about 12 μm of thickness to provide a suitable height difference between the first electrode 22 and the electron emission regions 26, of about from 1 μm to about 10 μm.

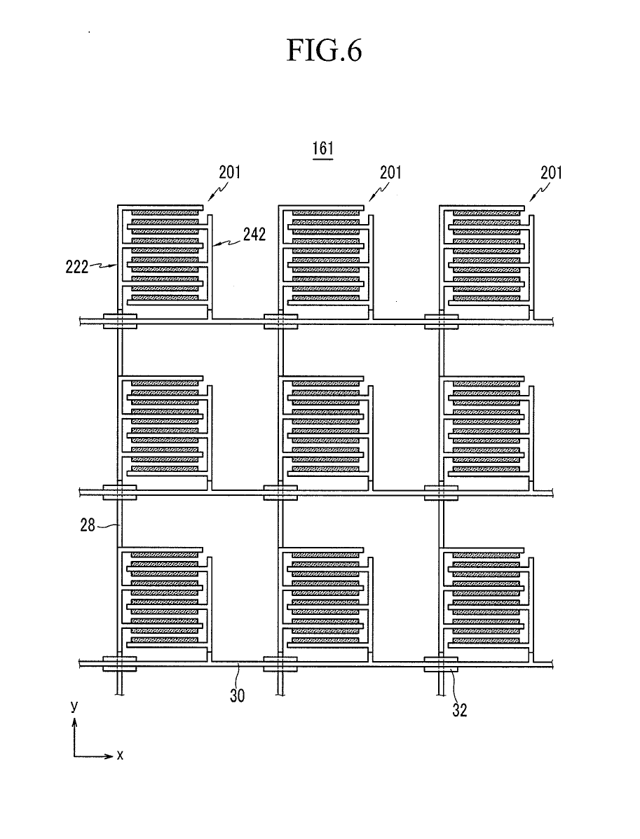

A light emission device according to a second exemplary embodiment will be described with reference to FIGS. 5 to 9.

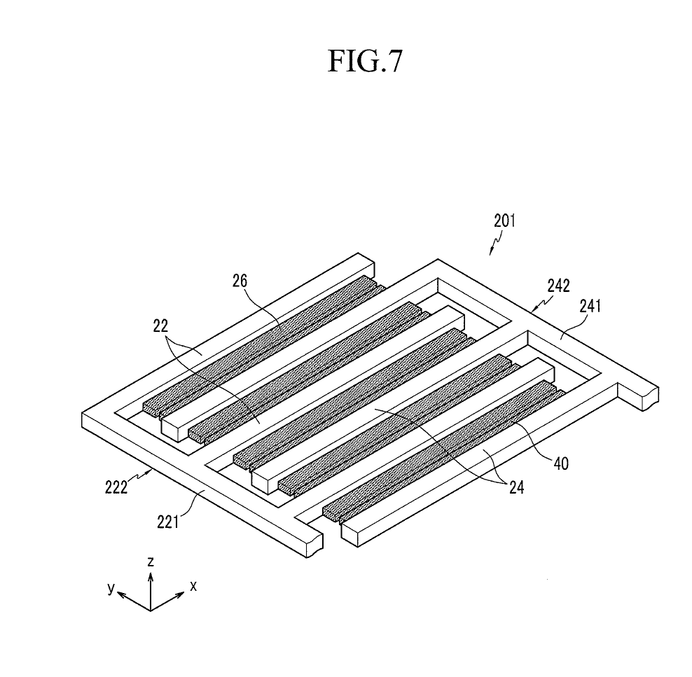

Referring to FIG. 5 to FIG. 7, the light emission device 101 of the present exemplary embodiment has a similar configuration as the light emission device 100 of the first exemplary embodiment, except that second electron emission regions 40 are added to the electron emission elements 201. Like reference numerals are used for like elements to the first exemplary embodiment, and the reference numeral 161 in FIG. 5 and FIG. 6 designates an electron emission unit.

In the present exemplary embodiment, each of the electron emission elements 201 includes first electrodes 22 spaced apart from each other by a predetermined interval along a first direction of the first substrate 12, e.g., the y-axis direction in drawings, second electrodes 24 arranged between the first electrodes 22 along the first direction, electron emission regions 26 disposed on side surfaces of the first electrodes 22 facing the second electrodes 24, and electron emission regions 40 disposed on side surfaces of the second electrodes 24 facing the first electrodes 22.

Hereinafter, the first electron emission regions designate the electron emission regions 26 connected to the first electrodes 22, and the second emission regions designate the electron emission regions 40 connected to the second electrodes 24. The first and second electron emission regions 26 and 40 are formed at lower heights than the first and second electrodes 22 and 24.

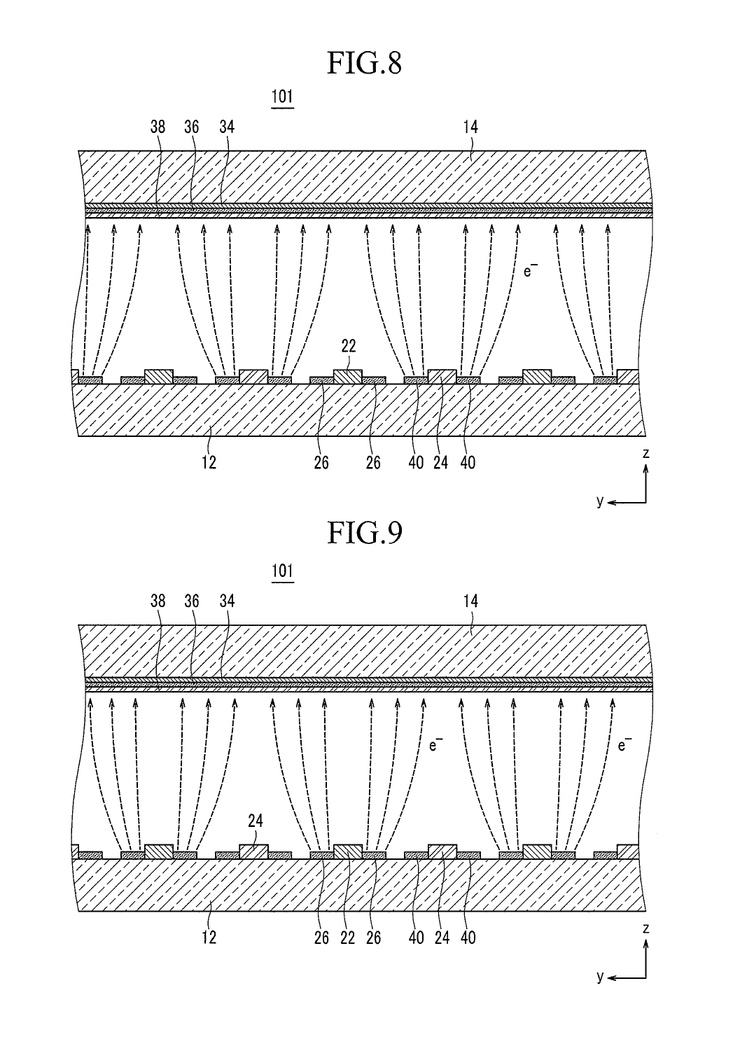

Referring to FIG. 7, a first connection electrode 221 is disposed at one end of each of the first electrodes 22 to form a first electrode set 222 together with the first electrodes 22. A second connection electrode 241 is disposed at one end of each of the second electrodes 24 to form a second electrode set 242 together with the second electrodes 24. The first electron emission regions 26 and the second electron emission regions 40 are separated from each other so as not to short-circuit with each other.

Like the first exemplary embodiment, the first and second electrodes 22 and 24 may be formed at a height of from about 1 μm to about 10 μm higher than the first and second electron emission regions 26 and 40. The first and second electron emission regions 26 and 40 may be from about 1 μm to about 2 μm thick, and the first and second electrodes 22 and 24 may be from about 3 μm to about 12 μm thick.

The first and second electron emission regions 26 and 40 may be spaced apart from each other at from about 3 μm to about 20 μm. If the distance between the first and second electron emission regions 26 and 40 is less than about 3 μm, a short-circuit may occur, and the manufacturing cost may also increase due to fine patterning. If the distance between the first and second electron emission regions 26 and 40 is more than about 20 μm, the emission efficiency of the first and second electron emission regions 26 and 40 may be deteriorated, resulting in an increased driving voltage.

The light emission device 101 of the present exemplary embodiment may be driven using a method in which a scan driving voltage and a data driving voltage are alternatively applied to the first and second electrodes 22 and 24. Then, electrodes to which the lower voltage of the scan and data driving voltages is applied become cathode electrodes, and electrodes to which the higher voltage is applied become gate electrodes.

In other words, the light emission device 101 may apply a scan driving voltage to the first electrodes 22 through the first wires 28 and a data driving voltage to the second electrodes 24 through the second wires 30 during a first time period. Then, the light emission device 101 may apply a scan driving voltage to the second electrodes 24 through the second wires 30 and a data driving voltage to the first electrodes 24 through the first wires 28 during a second time period.

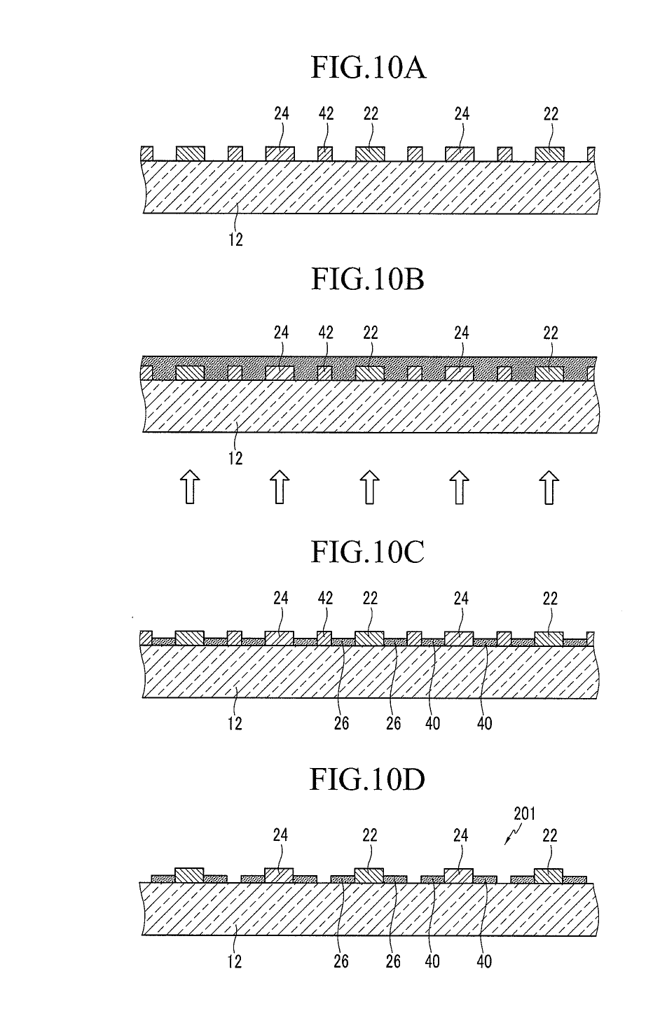

If the scan driving voltage is higher than the data driving voltage, the second electrodes 24 become cathode electrodes, and electrons (represented as e⁻ in FIG. 8) are emitted from the second electron emission regions 40, exciting the phosphor layer 36 during the first time period. During the second time period, the first electrodes 22 become cathode electrodes, and electrons (represented as e⁻ in FIG. 9) are emitted from the first electron emission regions 26, exciting the phosphor layer 36.

By alternately driving during the first time period and the second time period, electrons can be taken out of the first electron emission regions 26 and the second electron emission regions 40 in turn. Using such a driving method, since each electron emission regions 26 and 40 has a reduced load, the life-span of the electron emission regions 26 and 40 can increase, and the luminance of the light emission surface can improve.

Table 1 shows experimental results of the high voltage stability of the light emission device according to the variation in the height difference between electrodes and electron emission regions. The high voltage stability indicates a maximum anode voltage in which arc discharge and diode emission do not occur while the light emission device is driving. In the light emission device used for this experiment, the data voltage is 0 V.

TABLE 1

| | Height difference | Distance between the | | Electron | High |
|---|---|---|---|---|---|
| | between electrode and | first and second electron | Scan | density of | voltage |
| | electron emission region | emission regions | voltage | electron beam | stability |
| | (μm) | (μm) | (V) | (μm/cm²) | (kV) |
| First | 3 | 5 | 55 | 6.2 | 15 |
| Embodiment | | | | | |
| Second | 4 | 10 | 105 | 6.32 | 15 |
| Embodiment | | | | | |
| Third | 10 | 10 | 110 | 6.57 | 15 |
| Embodiment | | | | | |
| First | 0.3 | 10 | 100 | 6.7 | 4.6 |
| Comparative | | | | | |
| Example | | | | | |
| Second | 0.5 | 10 | 99 | 6.13 | 5.4 |
| Comparative | | | | | |
| Example | | | | | |

The first and second comparative examples, in which the height difference between the electrodes and electron emission regions is less than 1 μm, have a lower shield effect of the anode electric field and below 6 kV of high voltage stability. On the contrary, the exemplary embodiments 1 to 3, in which the height difference between the electrodes and electron emission regions is in the about 1 μm to about 10 μm range, can handle 15 kV at the anode electrode while effectively suppressing arc discharge and diode emission.

Meanwhile, in the aforementioned first and second exemplary embodiments, as the distance between the first electrode 22 and the second electrode 24 increases, the shield effect of the anode electric field on the electron emission regions 26 and 40 decreases. Therefore, the first and second electrodes 22 and 24 may be separated from each other by from about 30 μm to about 200 μm.

Table 2 shows experimental results of the high voltage stability of the light emission device according to the variation in the distance between the first and second electrodes. The efficiency of the light emission device is a luminance value divided by power consumption.

TABLE 2

| | Distance between first | Distance between first and | High voltage | |
|---|---|---|---|---|
| | and second electrodes | second electron emission regions | stability | Efficiency |
| | (μm) | (μm) | (kV) | (lm/W) |
| Third Comparative | 20 | 10 | 15 | 20.3 |
| Example | | | | |
| Fourth Embodiment | 30 | 10 | 15 | 37.8 |
| Fifth Embodiment | 200 | 10 | 13.5 | 29.5 |
| Fourth Comparative | 250 | 10 | 11 | 21.6 |
| Example | | | | |

If the distance between the first electrode 22 and the second electrode 24 is less than about 30 μm, the shield effect of the anode electric field on the electron emission regions 26 and 40 grows excessively, thereby deteriorating the emission efficiency of the electron emission regions. The third comparative example, in which the distance between the first electrode and the second electrode is 20 μm, the 20.3 μm/W efficiency is lower than the efficiencies of the fourth and fifth embodiments.

If the distance between the first electrode 22 and the second electrode 24 is over about 200 μm, the shield effect of the anode electric field on the first and second electrodes 22 and 24 may deteriorate. Then, the high voltage stability of the light emission device may become lower, and a high voltage can not be applied to the anode electrode. Therefore, it becomes more difficult to realize high luminance. The fourth comparative example, in which the distance between the first electrode and the second electrode is 250 μm, has 11 kV of high voltage stability and 21.6 μm/W of efficiency, which is lower than the efficiencies of the fourth and fifth embodiments.

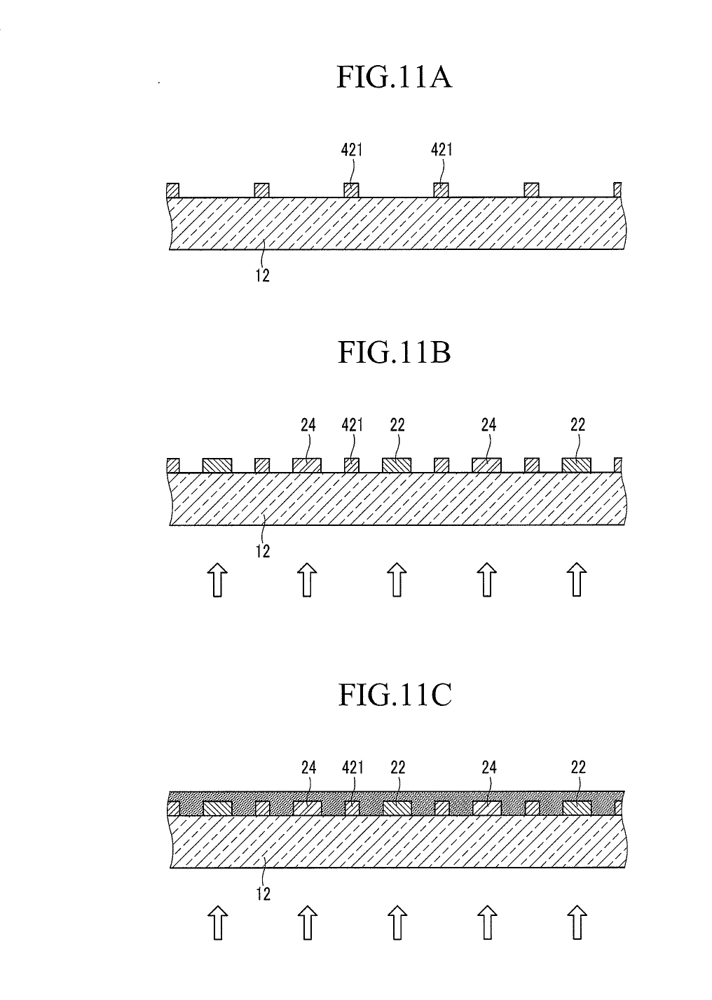

Next, a first method of manufacturing an electron emission element of the light emission device in the afore-mentioned second exemplary embodiment will be described with respect to FIG. 10A to FIG. 10D. Referring to FIG. 10A, a conductive layer is formed by laminating a metal sheet or screen-printing metal paste on a first substrate 12, and the first and second electrodes 22 and 24 and a sacrifice layer 42 are simultaneously formed by patterning the conductive layer. The metal sheet may comprise an aluminum (Al) sheet, and the metal paste may include silver (Ag).

The first and second electrodes 22 and 24 may be from about 3 μm to about 12 μm height and spaced at from about 30 μm to about 200 μm of distance from each other. The sacrifice layer 42 may be about from about 3 μm to about 20 μm wide.

Referring to FIG. 10B, a pasty mixture including an electron emission material and a photosensitive material is screen-printed on the first substrate 12. The electron emission material may include a material selected from a group consisting of carbon nanotubes, graphite, graphite nanofibers, diamond, diamond-like carbon, fullerenes, silicon nanowires, and combinations thereof. On the other hand, a carbide-derived carbon may be used as the electron emission material, as discussed above.

Next, the mixture is irradiated from the rear surface of the first substrate 12 (see the arrows) with ultraviolet (UV) radiation, which selectively hardens the irradiated portion of the printed mixture. The first electron emission regions 26 are formed between the first electrodes 22 and the sacrifice layer 42, and the second electron emission regions 40 are formed between the second electrodes 24 and the sacrifice layer 42 by removing the non-hardened portions of the mixture through a developing process, as shown in FIG. 10C.

At this time, the printing thickness of the mixture and the UV radiating time may be controlled so that the first and second electron emission regions 26 and 40 are lower than the first and second electrodes 22 and 24. The first and second electron emission regions 26 and 40 may be from about 1 μm to about 2 μm thickness.

Finally, the dimension of the space or gap between the first electron emission regions 26 and the second electron emission regions 40 is formed by removing the sacrifice layer 42, as shown in FIG. 10D. The electron emission element 201 is completed though this process.

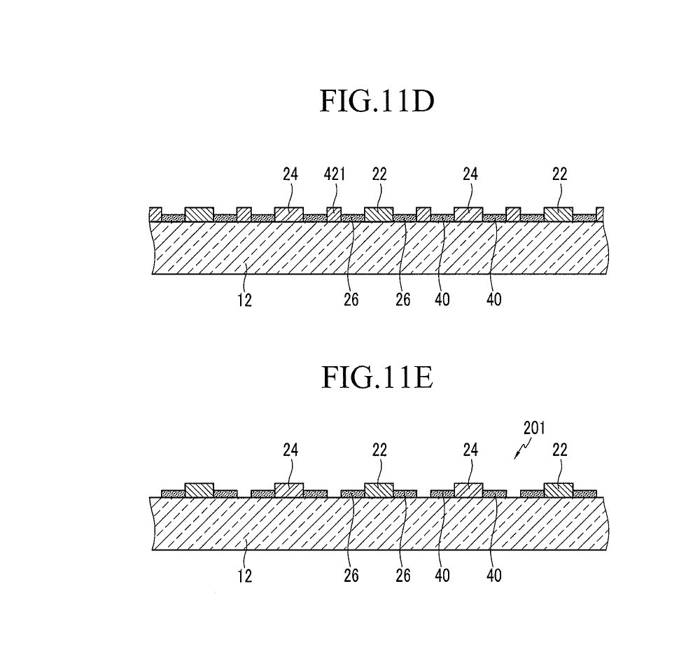

Hereinafter, a second method of manufacturing an electron emission element in a light emission device according to the second exemplary embodiment will be described with reference to FIG. 11A to FIG. 11E. Referring to FIG. 11A, a conductive layer is formed by laminating metal sheet on the first substrate 12, and a sacrifice layer 421 is formed by patterning the conductive layer. The metal sheet may comprise an aluminum (Al) sheet, and the sacrifice layer 42 may be from about 3 μm to about 20 μm of wide.

Referring to FIG. 11B, a conductive layer is formed by screen-printing a metal paste on the first substrate 12, and the first electrodes 22 and the second electrodes 24 are formed by patterning the conductive layer. The metal paste may include silver (Ag). The first electrodes 22 and the second electrodes 24 may be from about 3 μm to about 12 μm height, and the distance between the first electrode 22 and the second electrode 24 may be from about 30 μm to about 200 μm.

Referring to FIG. 11C, a pasty mixture including an electron emission material and a photosensitive material is screen-printed on the first substrate 12, which is then irradiated from the rear surface of the first substrate 12 (see the arrows) with ultraviolet (UV) radiation, thereby selectively hardening the irradiated portions of the printed mixture. The first electron emission regions 26 and the second electron emission regions 40 are formed by removing the non-hardened portions of the mixture through a developing process, as shown in FIG. 11D.

Finally, the gap or space between the first electron emission regions 26 and the second electron emission regions 40 is formed by removing the sacrifice layer 421, as shown in FIG. 11E. The first and second electron emission regions 26 and 40 may be from about 1 μm to about 2 μm thick and spaced at a distance corresponding to the width of the sacrifice layer 421. The electron emission element 201 is completed through this process.

In the aforementioned electron emission element 201, the first electrodes 22 and the second electrodes 24 are higher than the electron emission regions 26 and 40. Therefore, the first electron emission regions 26 and the second electron emission regions 40 stably contact the first electrodes 22 and the second electrodes 24, respectively. As a result, the emission characteristics of the electron emission regions 26 and 40 can be improved.

Also, the first electrodes 22 and the second electrodes 24 formed through a thick film process have a resistance lower than those of electrodes formed through a thin film process. Therefore, the light emission device 101 can minimize the voltage drop of the first electrodes 22 and the second electrodes 24, thereby improving luminance uniformity.

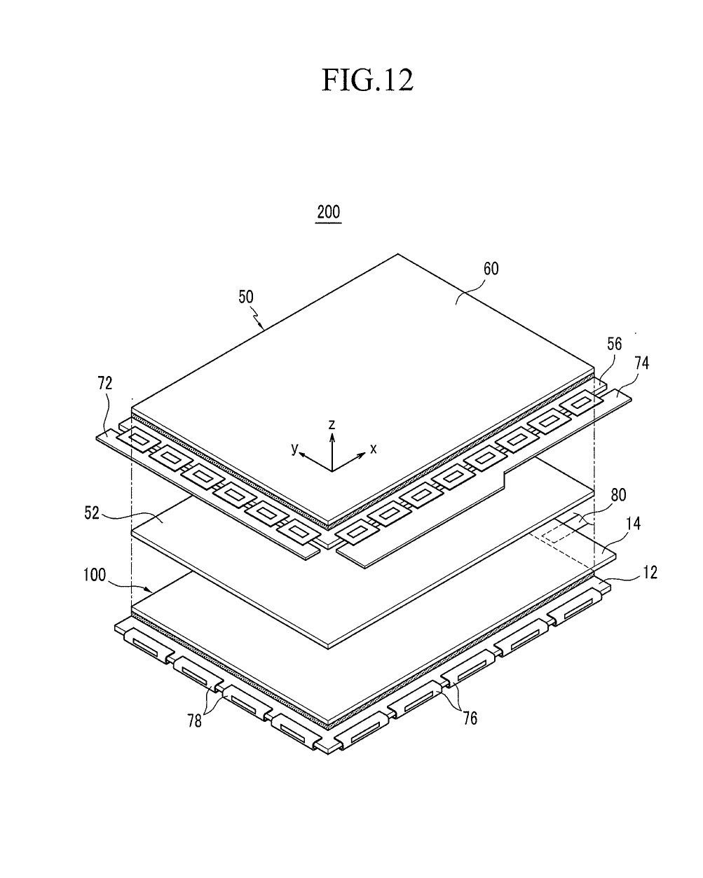

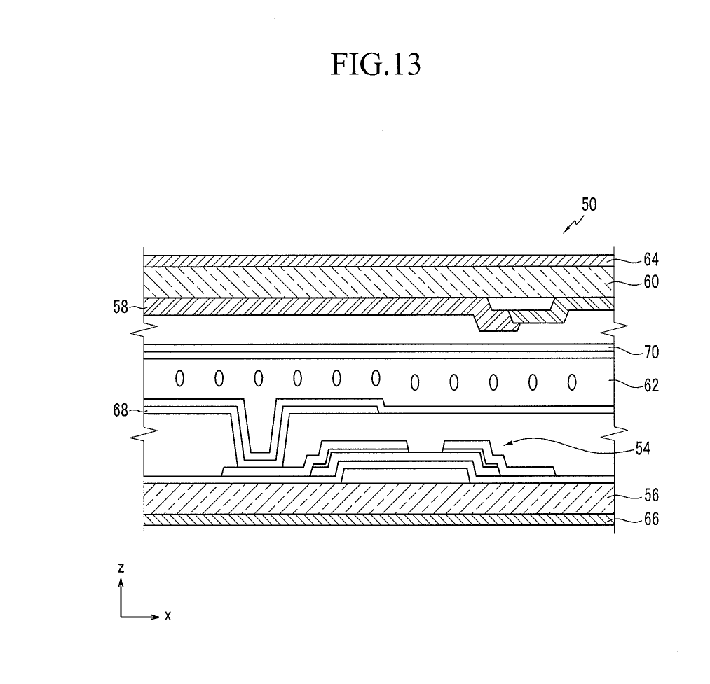

FIG. 12 is an exploded perspective view of a display device 200 using the light emission device according to one of the first and second exemplary embodiments as its light source. FIG. 13 is a partial cross-sectional view of a display panel shown in FIG. 12. Referring to FIG. 12, a display device 200 according to the present exemplary embodiment includes a light emission device 100 and a display panel 50 disposed at the front of the light emission device 100. A light diffuser 52 may be disposed between the light emission device 100 and the display panel 50 to uniformly diffuse light emitted from the light emission device 100. The light diffuser 52 and the light emission device 100 are spaced from each other at a predetermined distance.

Although the display device 200 includes the light emission device 100 according to the first exemplary embodiment as its light source in FIG. 12, the display device 200 may alternatively use the light emission device 101 according to the second exemplary embodiment as its light source. The display panel 50 may be a liquid crystal display panel or a non-emissive display panel. Hereinafter, the display device 200 will be described to have a liquid crystal display panel as the display panel 50.

Referring to FIG. 13, the display panel 50 includes a lower substrate 56 having a plurality of thin film transistors (TFT) 54, an upper substrate 60 having color filter layers 58, and a liquid crystal layer 62 interposed between the substrates 56 and 60. An upper polarizing plate 64 and a lower polarizing plate 66 are attached on the top of the upper substrate 60 and the bottom of the lower substrate 56 for polarizing light passing through the display panel 50.

Transparent pixel electrodes 68 controlled by TFT 54 are disposed at an inner surface of the lower substrate 56 for each sub-pixel, and the color filter layer 58 and a transparent common electrode 70 are disposed at an inner surface of the upper substrate 60. The color filter layers 58 include a red filter layer, a green filter layer, and a blue filter layer for each sub-pixel.

When the TFT 54 of a predetermined sub-pixel is turned on, an electric field is formed between the pixel electrode 68 and the common electrode 70, and the arrangement angle of liquid crystal molecules changes according to the electric field. Therefore, the light transmittance varies with the arrangement angle. The display panel 50 can control the luminance and emitted color of each pixel through this process described above.

In FIG. 12, a reference numeral 72 denotes a gate circuit board assembly for transmitting a gate driving signal to a gate electrode of each TFT 54, and a reference numeral 74 denotes a data circuit board assembly for transmitting a data driving signal to a source electrode of each TFT 54.

Referring to FIG. 12 again, the light emission device 100 include fewer pixels than those of the display panel 50 such that one pixel of the light emission device 100 corresponds to more than two pixels of the display panel 50. Each pixel of the light emission device 100 can emit light corresponding to the highest gray level among a plurality of pixels of the display panel 50, and can express 2 to 8 bits of gray level.

For convenience, a pixel of a display panel 50 is referred to as the first pixel, and a pixel of a light emission device 100 is referred to as the second pixel. The first pixels corresponding to one second pixel is referred to as the first pixel group.

A method for driving the light emission device 100 may include (a) detecting the highest gray level among the first pixels of the first pixel group at a signal controller (not shown) controlling the display panel 50, (b) calculating a gray level for the second pixel to emit light according to the detected gray level and transforming the calculated gray level to digital data, (c) generating a driving signal of the light emission device 100 using the digital data, and (d) applying the generated driving signal to the driving electrode of the light emission device 100.

The driving signal of the light emission device 100 is formed of a scan driving signal and a data driving signal. One of the first electrodes and the second electrodes, for example the second electrodes, receives a scan driving signal, and the other, for example, the first electrodes, receives a data driving signal.

A scan circuit board assembly and a data circuit board assembly may be disposed at the rear surface of the light emission device 100 for driving the light emission device 100. In FIG. 12, a reference numeral 76 denotes the first connector for connecting the first electrodes and the data circuit board assembly, and a reference numeral 78 denotes the second connector for connecting the second electrodes and the scan circuit board assembly. A reference numeral 80 denotes a third connector for applying an anode voltage to an anode electrode.

Meanwhile, the light emission device 101 according to the second exemplary embodiment can use a driving method that alternatively applies a scan driving voltage and a data driving voltage to the first electrodes and the second electrodes. To do so, the first electrodes are connected to the scan circuit board assembly and the data circuit board assembly through the first connector 76, and the second electrodes are also connected to the scan circuit board assembly and the data circuit board assembly through the second connector 78.

The second pixel of the light emission device 100 is synchronized with the first pixel group and emits light at a predetermined gray level when an image is displayed on the corresponding first pixel group. That is, the light emission device 100 provides light with a high luminance to a bright area of the display panel 50 and provides light with a low luminance to a dark area of the display panel 50. Therefore, the display device 200 of the present exemplary embodiment can increase the contrast of the screen and provide a sharp image quality.

Although exemplary embodiments have been described in detail hereinabove, it should be clearly understood that many variations and/or modifications of the basic concept taught herein still fall within the spirit and scope of the disclosure, as defined by the appended claims and their equivalents.

What is claimed is:

1. A light emission device comprising:
first and second substrates facing each other with a predetermined distance therebetween;
an electron emission unit disposed on a first side of the first substrate, comprising a plurality of electron emission elements; and
a light emission unit disposed on a first side of the second substrate, configured for emitting visible light,
wherein each electron emission element comprises
first electrodes spaced apart from each other by a predetermined interval along a first direction of the first substrate;
second electrodes arranged between the first electrodes along the first direction; and
first electron emission regions electrically coupled to the first electrodes with a predetermined height lower than a height of the first electrodes.

2. The light emission device of claim 1, wherein a height difference between the first electrodes and the first electron emission regions is from about 1 μm to about 10 μm.

3. The light emission device of claim 1, wherein a spacing between the first electrodes and the second electrodes is from about 30 μm to about 200 μm.

4. The light emission device of claims 1, wherein the electron emission element comprises second electron emission regions electrically coupled to the second electrodes with a predetermined height that is lower than a height of the second electrodes.

5. The light emission device of claim 4, wherein a height difference between the second electrodes and the second electron emission regions is from about 1 μm to about 10 μm.

6. The light emission device of claim 4, wherein a spacing between the first electron emission regions and the second electron emission regions is from about 3 μm to about 20 μm.

7. The light emission device of claim 4, wherein the first electrodes and the second electrodes are configured to receive a scan driving voltage and a data driving voltage during a first time period, and to receive a data driving voltage and a scan driving voltage during a second time period.

8. The light emission device of claim 4, wherein the first electron emission regions and the second electron emission regions comprises carbide-derived carbon.

9. The light emission device of claim 1, wherein the electron emission element includes a first connection electrode disposed at first ends of the first electrodes and forming a first electrode set together with the first electrodes, and a second connection electrode disposed at first ends of the second electrodes and forming a second electrode set together with the second electrodes.

10. The light emission device of claim 9, wherein the electron emission unit includes first wires coupled to the first connection electrodes of the electron emission elements arranged along a first direction of the first substrate and second wires connected to the second connection electrodes of the electron emission elements arranged along a second direction crossing the first direction.

11. A display device comprising:
a display panel configured for displaying an image; and
a light emission device configured for providing a light to the display panel,
wherein the light emission device comprises a first substrate and a second substrate facing each other with a predetermined distance therebetween; an electron emission unit disposed on a first side of the first substrate, comprising a plurality of electron emission elements; and a light emission unit disposed on a first side of the second substrate and configured for emitting a visible light,
wherein each of the electron emission elements comprises first electrodes spaced apart from each other by a predetermined interval along a first direction of the first substrate; second electrodes arranged between the first electrodes along the first direction; and first electron emission regions electrically coupled to the first electrodes, with a predetermined height that is lower than a height of the first electrodes.

12. The display device of claim 11, wherein a height difference between the first electrodes and the first electron emission regions is from about 1 μm to about 10 μm.

13. The display device of claim 11, wherein a spacing between the first electrodes and the second electrodes is from about 30 μm to about 200 μm.

14. The display device of claims 11, wherein the electron emission elements include second electron emission regions electrically coupled to the second electrodes, with a predetermined height lower than a height of the second electrodes.

15. The display device of claim 14, wherein a height difference between the second electrodes and the second electron emission regions is from about 1 μm to about 10 μm.

16. The display device of claim 14, wherein a spacing between the first electron emission regions and the second electron emission regions is from about 3 μm to about 20 μm.

17. The display device of claim 11, wherein the display panel comprises first pixels, the light emission device comprises second pixels, wherein a number of second pixels is fewer than a number of first pixels, and each of the second pixels is configured for independently emitting light corresponding a gray level of the first pixels.

18. The display device of claim 17, wherein each of the second pixels includes an electron emission element.

19. The display device of claim 11, wherein the display panel comprises a liquid crystal display panel.
